(19) United States
(12) Patent Application Publication
(10) Pub. No.: US 2021/0079675 A1
(43) Pub. Date: Mar. 18, 2021

(54) Flexible Pool Fountain System

(71) Applicant: Kevin Goodwin, Satellite Beach, FL (US)

(72) Inventor: Kevin Goodwin, Satellite Beach, FL (US)

(21) Appl. No.: 16/522,645

(22) Filed: Sep. 16, 2019

(51) Int. Cl. E04H 4/12; B05B 17/08

(52) U.S. Cl. CPC E04H 4/12; B05B 17/08

(57) ABSTRACT

The present invention consists of a flexible pool fountain system that comprises modular segments that connect in a manner to form a conduit for the flow of water from the return inlet of a pools circulation system and in a direction to form a positional fountain feature. The connections are linked by male to female sockets that allow multi-axial positioning and the retention of shape until the system is repositioned. The flexible design permits the system of segments to be compact and have a minimal profile above and below the waterline. Within the system of conduit segments an inline sliding T-valve is used to enable the control of force at which the fountain is emitted onto the pools surface. The flexibility of the conduit segments also allows for the system to facilitate optimal positioning of a pools water return jet circulation flow. Three-way conduit segments, and the design of which they permit, allow for other embodiments to be connected that provide multiple points above the waterline that can be used to provide multiple fountain features.

### FIELD OF THE INVENTION

The present invention is a flexible pool fountain system that is utilized for projecting streams of water into a pool through a flexible modular conduit system. The present invention is attached to a pools existing water return inlet jet and provides for a multidirectional fountain feature and a directional flow capability of a pool's intended water circulation flow. The device has a minimal visual and physical profile due to its transparency and combination of flexible components.

### BACKGROUND

Pool fountains can provide aesthetic and auditory enhancing value to a swimming pool's environment. The disadvantages contained in many designs are those of the installation requirements that often require alterations of a pool's existing permanent structure, and the resulting costs and inconvenience. Prior pool fountain systems that suggest a method for reducing those challenges are cumbersome and significantly impacting on the pool environment. These designs significantly intrude into the swimming area and are a potential hazard for a swimmer. Prior art shows that these structures are very rigid and significantly protrude above and below the surface of a pool's waterline. Any previous methods for providing a fountain for a swimming pool environment must become a relatively permanent structure to the swimming area and are not easily removed without significant effort. Also, when these fountains are unable to utilize the pool pumps force to create a fountain, the cumbersome structure of the fountain must remain within the pool and remain visually intrusive, as well as, physically impeding upon the swimmer. Furthermore, these designs attach to a pools existing plumbing system and block the flow of water circulation jets that are intended to properly function and maintain pool water quality.

Therefore, a need exists for a novel transparent flexible pool fountain system that is safer, has a minimally invasive visual and physical profile above and below the waterline, is conveniently attached to a pools water circulation return inlet jet while also allowing for simple repositioning when not in use, and which by its design and method, functions to enhance the directional capabilities of the flow of water circulation.

In view of the disadvantages within the known types of pool fountain systems of known designs and configurations, the present invention provides a new and improved transparent flexible pool fountain system that is intended to effectively enhance pool water circulation through its directional flow capabilities, is more convenient to use, and is safer for the swimmer. As such, the general purpose of the present invention is to provide a new and improved transparent flexible pool fountain system and method which has all the advantages of previous designs and none of the disadvantages.

### BRIEF SUMMARY OF THE INVENTION

To attain this, the present invention essentially comprises a transparent flexible pool fountain system. A pool is provided. The pool has vertical walls and contains a quantity of water. The water has a water line. A pump is provided. The water is circulated through a water pump. The water pump draws water from an outlet and is returned at an inlet jet below the waterline. The water is pumped through the inlet jet and is ejected into the pool and provides circulation to the pool water. The inlet port has a female screw thread.

A PVC eyeball fitting with a female threaded connection is provided. The transparent eyeball fits between two threaded components that exist as part of the pools circulation system inlet return wall fitting jet and is threaded into the inlet port female screw thread. Transparent modular conduit segments connected by multi-axial ball and socket joints are provided. A transparent modular conduit segment with a threaded male connector on one end and a male socket joint on the other is provided and connected to the PVC eyeball piece through a male/female threaded connection.

A transparent inline sliding T-valve is provided. The opposing male socket end of the transparent modular conduit segment is connected to a female socket connection on transparent inline sliding T-valve. A transparent connecting rod is provided. The transparent inline T-valve consists of 2 components that provide a sliding mechanism and is held in place by a transparent connecting rod. The two sliding components allow for water flow to be directed both into the pool below the waterline and upwards towards the fountain feature. Transparent modular conduit segments are provided and are connected by male/female socket connections. The male/female socket connections allow for multi-axial positioning and retention of shape. A flexible vertical shaft is formed by multiple transparent modular conduit segment connections and is provided. The lower end of the flexible vertical shaft has a female connection socket and is connected to the upper male socket connection of the transparent inline sliding T-valve.

A transparent T-coupling modular conduit segment is provided. The transparent T-coupling segment has two male and one female socket connection points. The three connection points are positioned so that there is a lower female socket directed downward and parallel to the wall, a middle male socket directed outward and perpendicular to the wall, and a top male socket that is parallel to the wall and directed upward towards the waterline. The lower female socket of the transparent T-coupling conduit segment is attached to the upper end of the flexible vertical shaft's male socket connection. The transparent T-coupling conduit segment allows for increasing the single stream of water flowing from the inlet jet into multiple fountain streams. A transparent Y-type reducer coupling conduit segment is provided. The transparent Y-type reducer coupling conduit segment has a lower female socket connection and two male socket connections that form the upward angularly directed branches of the Y shape. The two upward angularly directed branches of the Y shape have a reduced internal conduit diameter. The reduced conduit diameter is used to maintain pressure for fountain force projection purposes. The lower female socket connection of the transparent Y-type reducer coupling conduit segment is connected to the top male socket connector of the transparent T-coupling conduit segment. Transparent modular conduit segments of the diameter appropriate to fit the reduced diameter male socket connections of the Y-type reducer coupling are provided and used to form two flexible vertical shaft conduit segments. The two reduced diameter flexible vertical shafts have an upper end and a lower end. The lower end of both flexible vertical shafts have a female socket and the upper ends both have a male socket. Each flexible vertical shaft is connected at their lower end female socket connection to one of the branches of the angularly upward directed male sockets of the Y-type reducer coupling conduit segment. The two flexible vertical shafts are positioned upwards and direct the flow of water above the waterline. Two transparent nozzles are provided with female socket connections and are of appropriate diameter to fit the two upward directed vertical shafts connected to the Y-type reducer coupling conduit segment. Each transparent nozzle is connected to the upper male socket end of the vertical shafts by their female socket connection. Each flexible vertical shaft, and attached nozzle, is then positioned so that the flow of water is projected into an arc shape and provides part of the fountain feature. A third flexible vertical shaft of original conduit diameter is formed by multiple transparent modular segments at the male/female socket connections and is provided. The lower end of the third flexible vertical shaft of original diameter has a female socket connection. The female socket connection of the third flexible vertical shaft is connected to the transparent T-coupling conduit segment at its middle and horizontally directed male socket connection. The third flexible vertical shaft connected to the transparent T-coupling conduit segment is positioned so that the conduit directs the flow of water above the waterline. A transparent nozzle is provided with a female socket connection. The transparent nozzle is connected to the upper male socket of the third flexible vertical shaft and projects the flow of water into an arc shape, and onto the surface of the pool of water.

Outlined above, rather broadly, are the basic features of the invention in order that the detailed description that follows may be better understood. There are, of course, additional features of the invention that will be described further and which will form the subject matter for later claims.

In this respect, before explaining at least one embodiment of the invention in detail, it is intended for understanding that the invention is not limited in its application to the details of construction and to the arrangements of the components detailed in the following description or illustrated in the drawings. The invention is capable of other embodiments and of being practiced and carried out in various ways. Also, it is to be understood that the terminology contained in this document are for descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The principal objects of the present invention are: to provide a novel and improved transparent flexible pool fountain system; to provide a structure with a profile that has minimal above and below waterline presence; to provide such an assembly which can be selectively configured in shape, and position, through frictional resistant jointly connected components which tends to retain the shape until reconfigured; to provide such an assembly which enables selective positioning and orientation of a fluid dispersing device; to provide an assembly that has an ease of flexibility that allows it to be easily positioned out of the path of a swimmer; to provide an assembly that is safe; to provide such an assembly with components that allow it to be easily connected to an existing pool structure; to provide an assembly that blends into the existing pool environment and does not alter the utilization of the swimming area of the pool; to provide an assembly that facilitates the continued circulation of pool water; and to provide an assembly that can be efficiently manufactured without overlooking the aesthetic impact to the pool environment.

It is therefore the object of the present invention to have all the advantages of the prior art fountain systems of known design and configurations and none of the disadvantages.

These together with other objects of the invention, along with the various features of novelty which characterize the invention, are pointed out as detail, for a better understanding of the invention, its operating advantages and the specific objects achieved by its uses. Reference should be made to the accompanying drawings and descriptive matter, but they are not intended to limit future improvements and/or modifications in design.

### BRIEF DESCRIPTION OF THE DRAWINGS

The terminology used herein is for describing the embodiments only and not intended to be limiting. The present disclosure is to be considered as an exemplification of the invention and is not intended to limit the invention to the specific embodiments illustrated by the figures or description below. For the purpose of visual representation, the transparency aspects are not depicted in the artwork.

FIG. 1 is a depiction of the flexible pool fountain system attached at the wall of a pool and viewed from the front.

FIG. 2 is a depiction of the flexible pool fountain system viewed from the right side.

FIG. 3 is a sectional view of the flexible pool fountain systems interconnecting modular conduit segments.

FIG. 4 is the flexible pool fountain system viewed from the rear

FIG. 5 is a depiction of the inline sliding T-valve in position 1 from the front right viewpoint.

FIG. 6 is the inline sliding T-valve as viewed from the top.

FIG. 7 is a depiction of a sectional viewpoint, indicated in FIG. 6, showing the internal chambers and mechanism of the inline sliding T-valve in position 1.

### DETAILED DESCRIPTION OF THE INVENTION

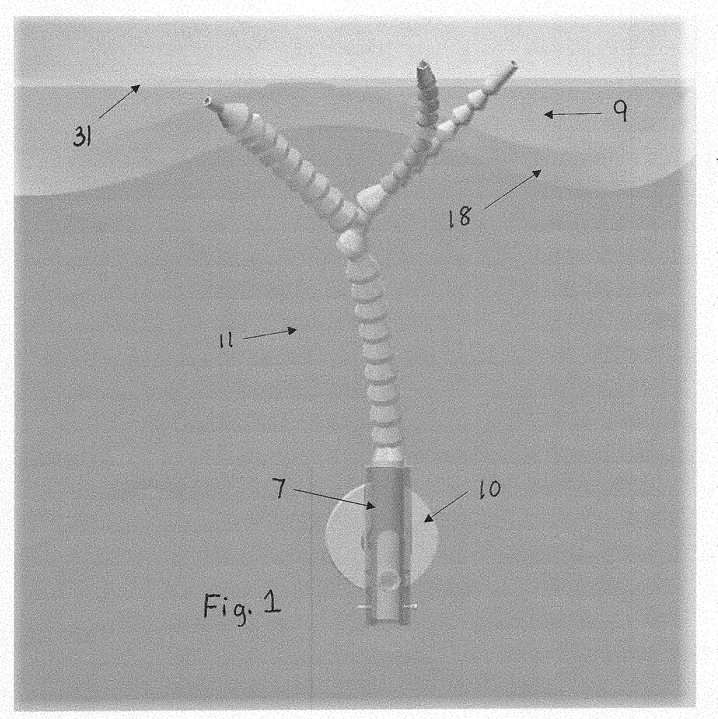

FIG. 1 shows the flexible pool fountain system (11) attached to a pool wall (9) at the water circulation inlet PVC eyeball fitting (10) and extending up past the waterline (18) and to the edge of the pool deck (31) FIG. 1 also shows the inline sliding T-valve (7).

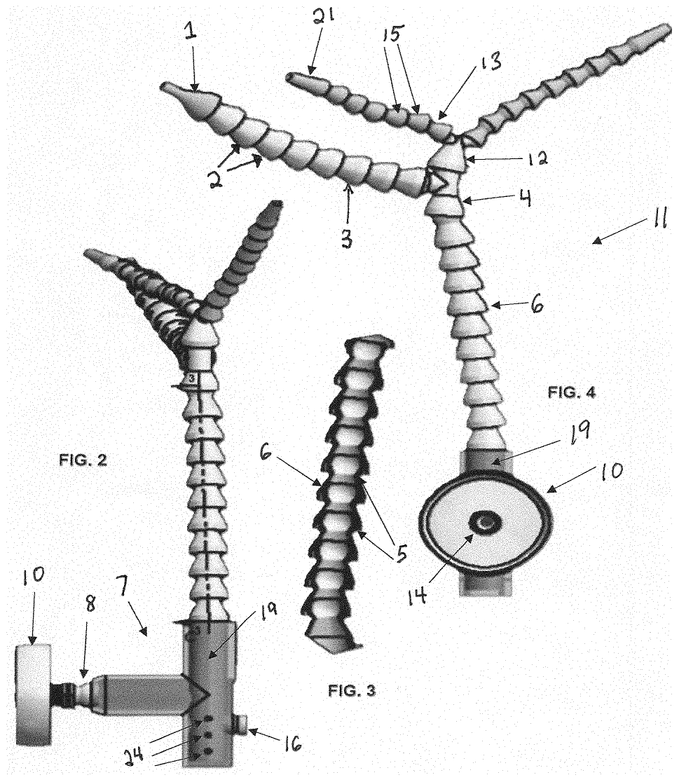

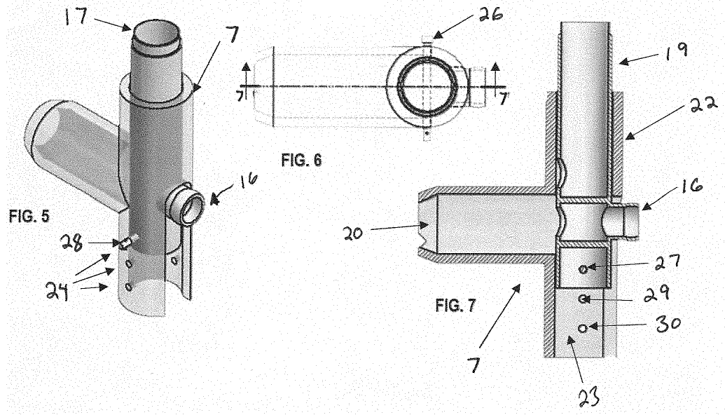

FIG. 2 depicts a flexible pool fountain system encompassing the present invention. FIG. 2 depicts the present invention viewed from the right side. FIG. 4 shows the present invention viewed from the rear. FIG. 3 shows the cross-sectional view, identified in FIG. 2, of the modular conduit segments internal male and female socket connections (5). The flexible pool fountain assembly (11) is connected to a standard female threaded water circulation inlet PVC eyeball fitting (10). The water flowing back into the pool from the return line enters through the eyeball hole (14) in FIG. 4. The eyeball fitting (10) is shown in FIG. 1. coming from the wall of a pool (9). The water circulation inlet PVC eyeball fitting (10) is attached to a threaded conduit coupler (8) through a male/female threaded connection as shown in FIG. 2. The threaded conduit coupler (8) attaches to the female socket (20), shown in FIG. 7, of the inline sliding T-valve (7). FIG. 4 shows the internal cylindrical pipe component (19) of the inline sliding T-valve (7) connecting to a flexible conduit shaft (6). The flexible conduit shaft (6) connects to the male snap connector (17) of the internal cylindrical pipe component (19) as shown in FIG. 5. The internal cylindrical pipe component (19) functions as a sliding mechanism for the valve function of the sliding T-valve (7). FIG. 3 shows a cross-sectional view of the flexible conduit shaft (6) from the perspective identified in FIG. 2. FIG. 3 shows the interconnections of several ball and socket modular conduit segments (5). FIG. 3 shows the flexible conduit shaft (6) positioned vertically and connecting to a T-coupler conduit segment (4). The T-coupler conduit segment (4) has a horizontally positioned opening connected to a flexible modular conduit shaft (3). The flexible conduit shaft (3) is formed by connected ball and socket conduit segments (2). The flexible conduit shaft (3) transitions above the waterline (18) shown in FIG. 1. The flexible conduit shaft (3) is attached to a nozzle (1) where water is ejected forming part of the fountain feature. The top of the vertical arm of the T-coupler conduit component (4) is connected to a Y-type reducer conduit segment (12). Each arm of the Y-type reducer conduit segment (12) is connected by a ball and socket connection to a diametrically reduced flexible shaft (13) that transitions above the waterline (18) as shown in FIG. 1. Each diametrically reduced flexible shaft (13) is formed by multiple diametrically reduced male/female socket conduit segments (15). Each diametrically reduced flexible shaft (13) is connected to a nozzle (21) where water is ejected forming part of the fountain feature.

FIG. 5 depicts the inline sliding T-valve (7) in position 1. Position 1 is intended for directing water circulation flow out of the return nozzle (16) for circulation into the pool of water below the waterline (18) as shown in FIG. 1. FIG. 7 depicts, the external T-shaped pipe component (22) provides a vertical lumen (23) for the internal cylindrical pipe component (19) to slide up and down between the three pin hole positions (24), shown in FIG. 5, and the single connection pin hole (27) on the internal cylindrical pipe component (19), shown in FIG. 7. When one of the three pin hole positions (24) on the external T-shaped pipe component (22) is aligned with the single pin hole (27) on the internal cylindrical pipe component (19), an attachment rod (26) can be threaded between the pin holes of both pipe components to secure the valve position. FIG. 6 shows a view from the top and shows the attachment rod (26) traversing through both valve components and connecting through the opposite wall. FIG. 3 depicts the inline sliding T-valve (7) in position 1 where the pinhole (27) on the internal cylindrical pipe component (19) is aligned with the upper most pinhole (28), of the three pinhole positions (24), on the external T-shaped pipe component (22), as shown in FIG. 5. When the single pin hole (27) of the internal cylindrical pipe component (19) is aligned with the middle pinhole (29) of the three pinhole positions (24) on the external T-shaped pipe component (22), position 2 is selected. Position 2 divides the flow of water to be directed towards both the below waterline flow, and upwards towards the fountain feature. When the single pin hole (27) of the internal cylindrical pipe component (19) is aligned with the lowest pinhole (30), position 3 is selected. Position 3 directs all water flow upwards towards the fountain feature.

What is claimed is:

1. A flexible pool fountain system consisting of a modular conduit assembly that is positional in a manner that allows for a reduction of physical profile, both above and below a pools waterline.

2. A flexible pool fountain system that connects to a pools existing water circulation plumbing and is easily removed when not in use.

3. A flexible pool fountain system that includes an inline sliding T-valve that allows for maintaining a pools water circulation jets below the waterline.

4. A flexible pool fountain system that is assembled from a combination of transparent interconnected articulating conduit segments that connect by ball and socket joints and allow for multiaxial positioning.
